(19) United States
(12) Patent Application Publication
(10) Pub. No.: US 2006/0082624 A1
(43) Pub. Date: Apr. 20, 2006

(54) Ink cartridge usable with a wide array type printer head

(76) Inventor: Young-Su Lee, Suwon-si (KR)

Correspondence Address: STANZIONE & KIM, LLP, 919 18TH STREET, N.W., SUITE 440, WASHINGTON, DC, 20006, US

(21) Appl. No.: 11/208,755

(22) Filed: Aug. 23, 2005

(30) Foreign Application Priority Data
Oct. 14, 2004 (KR) 2004-82363

(51) Int. Cl. B41J 2/175

(52) U.S. Cl. 347/86

(57) ABSTRACT

An ink cartridge usable with a wide array type printer head includes: an ink cartridge body extending in a lateral direction of a recording medium and having an ink storage space, at least one ink pipe formed at a bottom surface of the ink cartridge body and having at least two inlet ports in fluid communication with the ink storage space, an ink channel in fluid communication with a bottom surface of the at least one ink pipe, and at least one ink discharge port in fluid communication with the ink channel to supply the ink to a printer head. The ink cartridge is capable of increasing ink supply performance and use efficiency of ink absorbed in foam disposed in the ink cartridge body by increasing a local compression of the foam by forming a plurality of ink pipes having a cross-sectional area that is less than or equal to than a cross sectional area of a conventional ink pipe. In addition, the ink cartridge is capable of preventing air from being trapped in the foam by the increase in the local compression in the foam.

### CROSS-REFERENCE TO RELATED APPLICATIONS

This application claims the benefit of Korean Patent Application No. 2004-82363, filed Oct. 14, 2004, the disclosure of which is hereby incorporated herein by reference in its entirety.

### BACKGROUND OF THE INVENTION

1. Field of the Invention

The present general inventive concept relates to an ink cartridge usable with a wide array type printer head and, more particularly, to an ink cartridge to effectively supply ink to a wide array type printer head capable of simultaneously ejecting the ink over an entire lateral line of a recording medium.

2. Description of the Related Art

An inkjet printer is a device for performing a printing operation by ejecting fine ink droplets to a surface of a recording medium to form a desired shape. The inkjet printer uses an ink cartridge for storing and ejecting the ink. In general, the ink cartridge has a storage space for storing the ink therein, and a head chip for ejecting the stored ink at a bottom surface of the ink cartridge.

FIG. 1 is a cross-sectional view illustrating a conventional ink cartridge. Referring to FIG. 1, an ink pipe 14 is formed at a bottom surface of a cartridge case 10 made of synthetic resin to supply ink to a head chip 18 through the ink pipe 14. The ink pipe 14 projects from the bottom surface of the cartridge case 10 and includes a filter 16 at an upper end thereof to remove impurities or bubbles contained in the ink. Foam 12 is contained in the cartridge case 10, which generates appropriate negative pressure in the cartridge case 10 to stably eject the ink through the head chip 18 without leakage to an exterior.

The ink is absorbed and stored in the foam 12. Since the ink pipe 14 projects from the bottom surface of the cartridge case 10, as illustrated in FIG. 1, the foam 12 is partially compressed by the upper end of the ink pipe 14 when the foam 12 is inserted into the cartridge case 10. The compressed foam 12 more strongly absorbs the ink compared to uncompressed foam. As a result, the ink may be stably supplied from the cartridge case 10 into the ink pipe 14 when the foam 12 is compressed therein. However, in order to prevent a center portion of the filter 16 from sagging or being deformed due to the compressed foam 12, a partition is provided on a center portion of the ink pipe 14 at the upper end thereof to support the center portion of the filter 16.

Recently, a wide array type printer head capable of improving printing speed by simultaneously ejecting the ink over an entire lateral line of a recording medium has been developed. The wide array type printer head requires a large amount of ink, because its ink ejection amount per second for single color printing is a minimum of three times as large as an ink ejection amount of a conventional printer head and at least thirty times as large as the ink ejection amount of the conventional printer head for full color printing. Therefore, when the aforementioned ink cartridge structure is adapted to the wide array type printer head, a cross-sectional area of an ink pipe, at which the filter is to be attached, is larger.

However, with regards to the wide array type printer head, a compression effect of foam is decreased at a portion where the ink pipe is not in contact with a partition to deteriorate supply performance and use efficiency of ink absorbed in the foam.

In addition, the filter attached to an upper end of the ink pipe and the partition is deformed at a portion adjacent to the partition, when the filter sags due to pressure applied by the foam, to deteriorate filter performance and decrease filter strength. As a result, when a lid is attached to an upper portion of the ink cartridge by fusion bonding, fusion energy used to secure the lid to the ink cartridge may cause a portion of the filter to be separated from the upper end of the ink pipe and dust from the filter may block a nozzle formed at the printer head.

### SUMMARY OF THE INVENTION

The present general inventive concept provides an ink cartridge usable with a wide array type printer head capable of preventing deformation and performance degradation of a filter. The ink cartridge supplies sufficient ink required by the wide array type printer head, and maintains compression of foam inserted into the ink cartridge.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing an ink cartridge usable with a wide array type printer head including an ink cartridge body extending in a lateral direction of a recording medium and having an ink storage space, at least one ink pipe formed at a bottom surface of the ink cartridge body and having at least two inlet ports in fluid communication with the ink storage space, an ink channel in fluid communication with a bottom end of the at least one ink pipe, and at least one ink discharge port in fluid communication with the ink channel to supply the ink to a printer head.

The bottom surface of the ink cartridge body may include the at least one ink pipe with a plurality of inlet ports each having an area so that sufficient ink required by the wide array type printer head may be supplied thereto. Additionally, a smaller area maintains compression of foam used to absorb the ink in the ink storage space and prevent deformation of a filter used to filter dust from the at least one ink pipe.

A number of the at least two inlet ports of the at least one ink pipe may vary depending upon an ink supply amount. In addition, the at least one ink pipe may include a plurality of ink pipes.

The at least two inlet ports of the at least one ink pipe may be spaced apart from each other so that a compression efficiency of the foam inserted in the ink cartridge body may be increased by this spaced arrangement compared to an arrangement in which the at least two the inlet ports of the at least one ink pipe are disposed adjacent to each other. As a result of this spaced arrangement, the ink cartridge body smoothly supplies the ink to the printer head.

The at least two inlet ports may be uniformly distributed in an inner space of the ink cartridge body. The at least two inlet ports may not be disposed in a concentrated manner at a predetermined position in the inner space of the ink cartridge body so that the compression efficiency of the foam to absorb the ink may be maximized.

The inner space of the ink cartridge body may be divided into a plurality of spaces by one or more partitions, and the at least one ink pipe may include a plurality of ink pipes disposed in a plurality of spaces, respectively.

The ink channel may include at least one first channel in fluid communication with the bottom end of the at least one ink pipe, respectively, and a second channel in fluid communication with the at least one first channel and the at least one ink discharge port, respectively. That is, the at least one first channel may be formed in the same number as the plurality of ink pipes, and the second channel may be formed in the plurality of spaces divided by the one or more partitions, respectively. That is, the ink supplied into the respective ones of the plurality of ink pipes flows through the at least one first channel to be gathered in the second channel and is then supplied to the printer head through the at least one ink discharge port.

The at least one ink discharge port may be formed at the bottom surface of the second channel.

The second channel may be located closer to the bottom surface of the ink cartridge body than the at least one first channel. That is, bottom surfaces of the first and second channels may be disposed to form a step, thereby making the second channel have a capacity larger than the at least one first channel. In addition, since the ink cartridge body is generally manufactured using an injection mold, when the first and second channels are made to have the same height, a slide core of the injection mold is more deeply inserted therein, thereby making the ink cartridge more difficult to manufacture.

In order to guide the ink to flow to the second channel, the bottom surface of the at least one first channel may be sloped down toward the second channel.

The ink cartridge body may be provided with at least one slide core insertion groove in fluid communication with the second channel at one side thereof. The slide core of the injection mold may be used when the second channel is formed, and the at least one slide core insertion groove may be sealed with an individual cover and when the manufacture of the ink cartridge body is complete.

At least a portion of the second channel may be in direct fluid communication with the bottom end of the at least one ink pipe such that ink is received in the second channel without flowing through the at least one first channel. The bottom end of the at least one ink pipe may be in fluid communication with the second channel having a capacity larger than the first channel, thereby maintaining a smooth ink flow between the first and second channels.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic cross-sectional view illustrating a conventional ink cartridge;

FIG. 2 is a perspective view illustrating an ink cartridge usable with a wide array type printer head according to an embodiment of the present general inventive concept;

FIG. 3 is a partially cutout perspective view illustrating an upper portion of the ink cartridge of FIG. 2;

FIG. 4 is a perspective view illustrating a bottom surface of the ink cartridge of FIG. 2;

FIG. 5 is a cross-sectional view taken along the line a-a in FIG. 3;

FIG. 6 is a cross-sectional view taken along the line b-b in FIG. 3;

FIG. 7 is a partially cutout perspective view illustrating an ink cartridge usable with a wide array type printer head according to another embodiment of the present general inventive concept; and

FIG. 8 is a cross-sectional view taken along the line c-c in FIG. 7.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

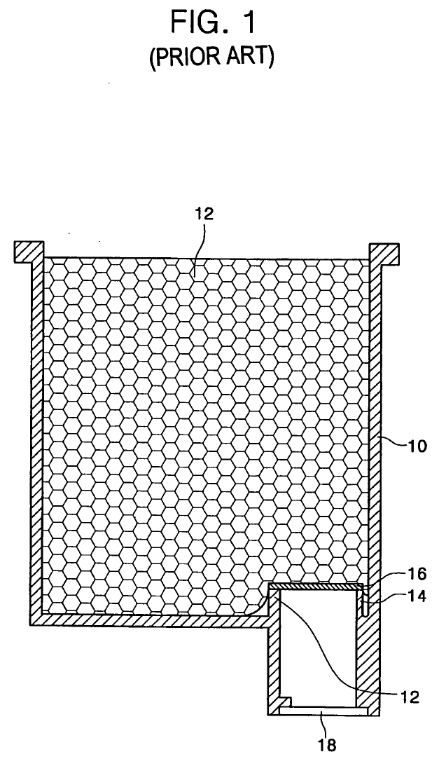

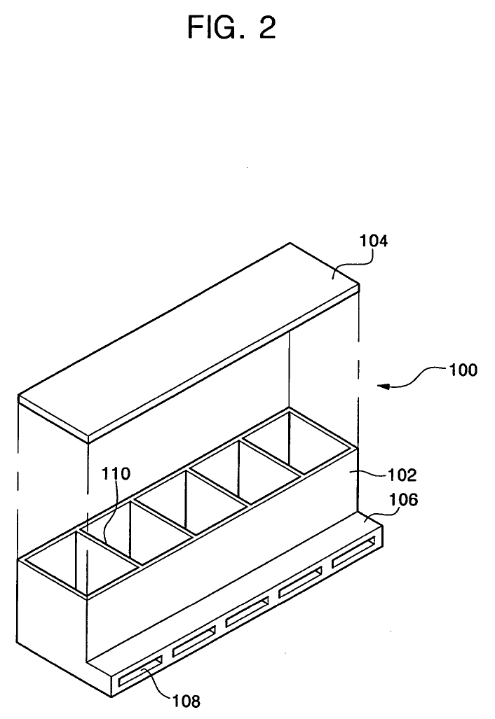

Referring to FIG. 2, a cartridge 100 according to an embodiment of the present general inventive concept is illustrated. The cartridge 100 includes a cartridge body 102 having a rectangular box shape and extending along a lateral length of a recording medium. In addition, the cartridge body 102 has an open upper part into which foam 12 (similar to FIG. 1) may be inserted. A lid 104 may be fusion-bonded to the upper part of the cartridge body 102 to seal an inner space of the cartridge body 102.

The inner space of the cartridge body 102 is divided into a plurality of small spaces by partitions 110. In the present embodiment, four partitions 110 are disposed in the inner space to form five small spaces of the cartridge body 102. Therefore, the foam 12 may be individually inserted into the five small spaces. The foam 12 inserted into the five small spaces may include five separate pieces of foam. Additionally, although FIG. 2 illustrates five small spaces defined by four partitions 110, it should be understood that other numbers of partitions and small spaces may be used with the present embodiment of the general inventive concept.

A projection 106 may project from a front surface of the cartridge body 102 along an entire longitudinal length of the cartridge body 102. The projection 106 may include a plurality of slide core insertion grooves 108 that are formed at the projection 106. The slide core insertion grooves 108 may have thin rectangular shapes extending through the projection 106 into bottom portions of the small spaces, respectively. In addition, the slide core insertion grooves 108 may be formed at the small spaces, respectively.

Each of the slide core insertion grooves 108 functions to insert a slide core (not shown) contained in a mold used to manufacture the cartridge body 102, and a second channel is formed by the slide core as described hereinafter. Once the manufacture of the cartridge body 102 is complete, the slide core insertion grooves 108 are sealed by individual covers (not shown) to prevent the ink from leaking through the slide core insertion grooves 108.

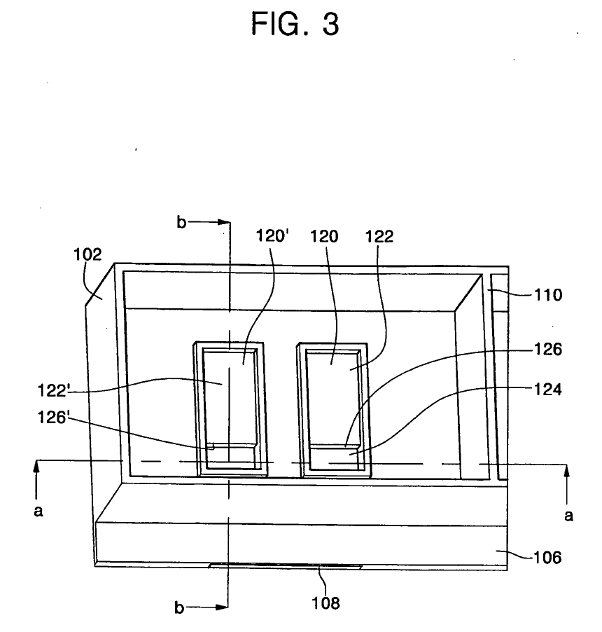

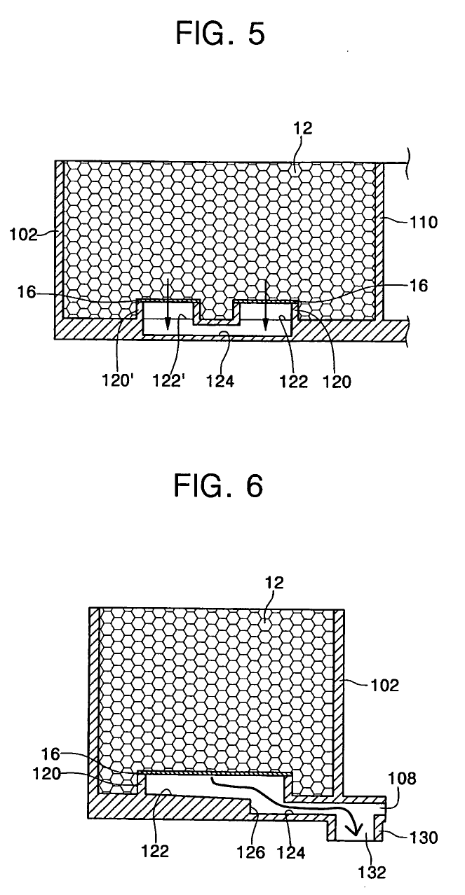

Referring to FIGS. 3 and 5, a bottom portion of one of the small spaces of FIG. 2 is illustrated. The small space may include two ink pipes 120 and 120′ having rectangular shapes and upper ends that project from the bottom portion of the small space. While a filter to remove impurities is attached to the upper ends of each of the ink pipes 120 and 120′, the filter is omitted from FIG. 3 in order to illustrate an inner structure of the small space. The ink pipes 120 and 120′ include first channels 122 and 122′ formed at a bottom end of the ink pipes 120 and 120′ to form a first ink flow path through which the ink is supplied from the ink pipes 120 and 120′ to an exterior. A bottom surface of the first channels 122 and 122′ is sloped down toward the projection 106. That is, the bottom surface of the first channels 122 and 122′ is inclined to allow the ink to flow downhill toward the projection 106.

In addition, the first channels 122 and 122′ are formed in the ink pipes 120 and 120″, and are separated from each other. Each of the ink pipes 120 and 120′ includes a second channel 124 formed at the bottom surfaces of the first channels 122 and 122′ adjacent to the projection 106. The second channel 124 may be shared by the ink pipes 120 and 120′ and the first channels 122 and 122′. Alternatively, the second channel 124 may include more than one second channel to correspond to each of the first channels 122 and 122′. The ink that passes through the first channels 122 and 122′ is gathered in the second channel 124 (see FIG. 5). The second channel 124 is located closer to a bottom surface of the cartridge body 102 than each of the first channels 122 and 122′. As a result, a step 126 may be formed where the first channels 122 and 122′ meet the second channel 124 so that the ink may flow downhill.

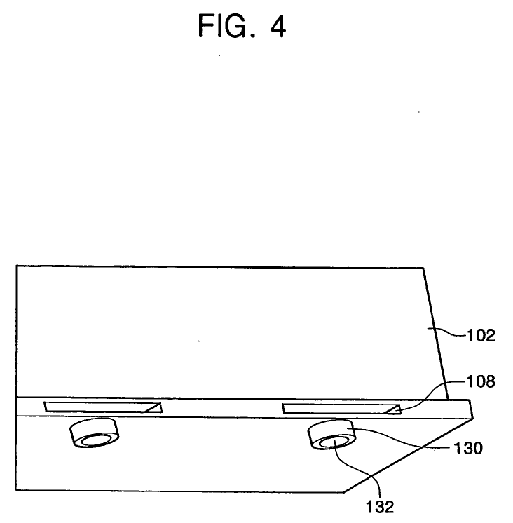

In addition, the second channel 124 may be formed by a slide core, and may be integrally formed with the slide core insertion groove 108. Referring to FIG. 4, a circular ink discharge port 130 is formed at the bottom surface of the cartridge body 102 to discharge the ink that flows along an ink flow path 132 that extends along the first channels 122 and 122′, the second channel 124, and the discharge port 130. The discharge port 130 discharges the ink to the exterior of the cartridge 100 to be supplied to a printer head (not shown). The cartridge 100 may include ink discharge ports to correspond to each of the small spaces. In other words, the ink discharge port 130 of the cartridge 100 includes five ink discharge ports in fluid communication with each of the second channels 124 that are individually formed in each of the respective small spaces. However, the number of the ink discharge ports may vary depending upon a diameter of the ink discharge port 130 and a required ink supply amount.

Hereinafter, operation of the ink cartridge 100 of FIGS. 2 to 4 will be described with reference to FIG. 6.

The foam 12 is compressed by each of the ink pipes 120 and 120′ since the ink pipes 120 and 120′ protrude from the bottom of the cartridge body 102 toward the foam 12. Since a cross-sectional area of each of the ink pipes 120 and 120′ is similar to that of a conventional ink pipe (i.e., the conventional ink pipe used in a non-wide array type printer head), the foam 12 is compressed by the same amount as the conventional ink pipe. When a plurality of ink pipes 120 and 120′ are formed, and the cross-sectional areas of the ink pipes 120 and 120′ is small, the amount of compression on the foam 12 may be increased.

In addition, a filter 16 (similar to FIG. 1) is attached to the upper end of the ink pipes 120 and 120′ and may have an area less than or equal to a conventional filter area to minimize filter deformation and prevent filtering effect from deteriorating. Further, since the filter 16 is stably supported by the upper end of the ink pipes 120 and 120′ to maintain constant tension even when the lid 104 (see FIG. 2) is attached, generation of dust caused by energy used to fuse the lid 104 to the cartridge body 102 may be minimized.

Ink absorbed in the foam 12 passes through the filter 16 attached to the upper end of each of the ink pipes 120 and 120′, and is then introduced into the first channels 122 and 122′ located at the bottom ends of the ink pipes 120 and 120′. In addition, a portion of the ink is directly introduced into the second channel 124. The ink introduced into the first channels 122 and 122′ flows down the sloped bottom surface thereof to be introduced into the second channel 124. In this process, since the second channel 124 has an area larger than that of each of the first channels 122 and 122′, the ink introduced through the first channels 122 and 122′ may flow smoothly without a bottleneck effect.

The ink introduced into the second channel 124 is supplied to the printer head through the ink flow path 132 that extends from the filter 16 to the ink discharge port 130.

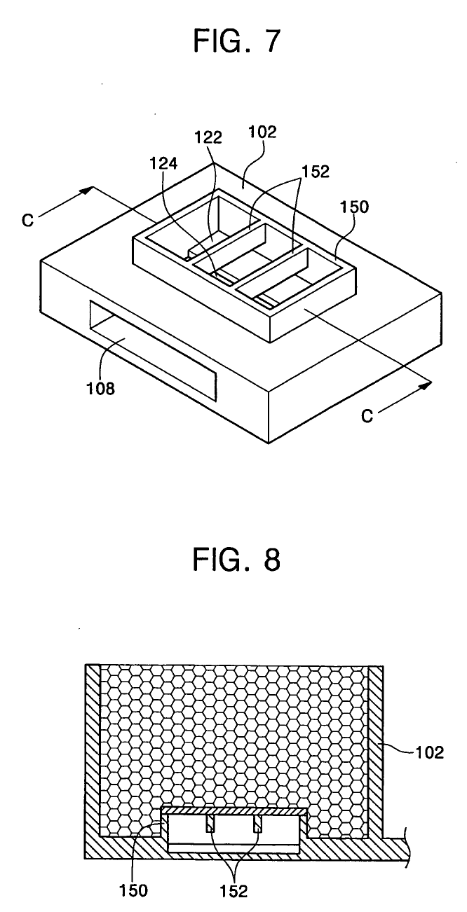

FIG. 7 illustrates an ink cartridge according to another embodiment of the present general inventive concept. The ink cartridge of FIG. 7 includes some of the same parts as the ink cartridge of FIG. 2. Corresponding parts will be referred to by the same reference numeral, and their descriptions will be omitted.

FIG. 7 illustrates a portion that corresponds to FIG. 2, in which sidewalls of the ink cartridge body 102 have been omitted for illustration. In the present embodiment, an ink pipe 150 has a rectangular cross-sectional area and two partitions 152 are formed at an upper end of the ink pipe 150, thereby forming three inlet ports at the upper end of the ink pipe 150.

While an upper surface of the partitions 152 exists on the same plane as the upper end of the ink pipe 150, a lower surface of the partitions 152 is spaced apart from the bottom surface of the first channel 122. Therefore, ink introduced through each of the inlet ports is primarily gathered in the first channel 122 to be introduced to the second channel 124 formed at an end of the first channel 122. The ink introduced to the second channel 124 is then discharged through the ink discharge port 132.

Alternatively, the bottom surface of the partitions 152 may extend to the bottom surface of the first channel 122 to gather the ink introduced through each of the inlet ports in the second channel 124 rather than the first channel 122.

As can be seen from the foregoing, the present general inventive concept is capable of increasing ink supply performance and use efficiency of the ink absorbed by the foam by increasing a local compression of the foam by supplying the ink through a plurality of ink pipes having cross-sectional areas that are less than or equal to conventional ink pipes.

In addition, the present general inventive concept is capable of preventing air from getting trapped in the foam by increasing the local compression of the foam, and preventing a nozzle in the printer head from getting blocked by reducing generation of filter dust during fusion of the lid to the cartridge body. Since a plurality of ink pipes absorb ultrasonic energy transmitted along sidewalls of the cartridge body during a lid attachment process, force applied to the filter is effectively reduced. As a result, less dust is dislodged from the filter.

Further, when the ink pipe has a large cross-sectional area, a portion of the compressed foam sags into the ink pipe to be closed to or in contact with the bottom end to reduce storage capacity of the ink. However, the present general inventive concept is capable of effectively preventing the filter from sagging since the present general inventive concept provides the filter having a similar area to conventional filters.

Furthermore, when the foam sags, the filter may be deformed the filtering effect may be reduced; however, the present general inventive concept may also prevent the filter from being deformed.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink cartridge usable with a wide array type printer head, comprising:
an ink cartridge body extending in a lateral direction of a recording medium and having an ink storage space and a printer head;
at least one ink pipe formed at a bottom surface of the ink cartridge body and having at least two inlet ports in fluid communication with the ink storage space;
an ink channel in fluid communication with a bottom end of the at least one ink pipe; and
at least one ink discharge port in fluid communication with the ink channel to supply ink to the printer head.

2. The ink cartridge according to claim 1, wherein the at least two inlet ports of the ink pipe are spaced apart from each other.

3. The ink cartridge according to claim 2, wherein the at least two inlet ports are uniformly distributed in an inner space of the ink cartridge body.

4. The ink cartridge according to claim 2, wherein an inner space of the ink cartridge body is divided into a plurality of spaces by one or more partitions, and the at least one ink pipe is disposed in the plurality of spaces, respectively.

5. The ink cartridge according to claim 1, wherein the ink channel comprises at least one first channel in fluid communication with the bottom end of the at least one ink pipe, respectively, and a second channel in fluid communication with the at least one first channel and the at least one ink discharge port, respectively.

6. The ink cartridge according to claim 5, wherein the at least one ink discharge port is formed at the bottom surface of the second channel.

7. The ink cartridge according to claim 6, wherein the second channel is located closer to the bottom surface of the ink cartridge body than the at least one first channel.

8. The ink cartridge according to claim 7, wherein a bottom surface of the at least one first channel is sloped down toward the second channel.

9. The ink cartridge according to claim 5, wherein the ink cartridge body includes at least one slide core insertion groove in fluid communication with the second channel at one side thereof.

10. The ink cartridge according to claim 5, wherein at least a portion of the second channel is in direct fluid communication with the bottom end of the ink pipe such that ink is received in the second channel without flowing through the at least one first channel.

11. An ink cartridge usable with a wide array type printer head, comprising:
a cartridge body having a length that corresponds to a length of the wide array type printer head;
one or more space partitions to divide an inner space of the cartridge body and to define at least two ink spaces in which at least two corresponding pieces of foam are to be inserted; and
an ink flow path to enable ink to flow from the at least two pieces of foam to the wide array type printer head,
wherein each of the at least two ink spaces comprises at least two ink pipes in fluid communication with the ink flow path.

12. The ink cartridge according to claim 11, wherein the at least two ink pipes include at least two filters disposed on upper ends thereof.

13. The ink cartridge according to claim 11, wherein the ink flow path comprises at least one discharge port at a bottom surface of the cartridge body to supply ink to the wide array type printer head.

14. The ink cartridge according to claim 13, wherein the ink flow path further comprises at least one shared channel to collect ink received from the at least two ink pipes and to supply the ink to the at least one discharge port.

15. The ink cartridge according to claim 14, wherein the ink flow path further comprises at least two non-shared channels that correspond to the at least two ink pipes to receive ink from the at least two ink pipes, respectively, and to supply the ink to the at least one shared channel.

16. The ink cartridge according to claim 15, wherein the at least two non-shared channels have bottom surfaces that are inclined to enable ink to flow downhill toward the at least one shared channel that is disposed toward a front surface of the ink cartridge body.

17. The ink cartridge according to claim 15, wherein the cartridge body comprises a
step at which the at least two non-shared channels meet the at least one shared channel.

18. The ink cartridge according to claim 11, wherein the ink flow path comprises at least two first channels that correspond to the at least two ink pipes including one or more pipe partitions disposed therebetween and at least one second channel to receive ink supplied by the at least two first channels.

19. The ink cartridge according to claim 18, wherein the one or more pipe partitions extend to a bottom surface of the at least two first channels to individually supply the at least one second channel with ink.

20. The ink cartridge according to claim 18, wherein the one or more pipe partitions extend partially along a length of the at least two first channels so that the ink supplied by the at least two ink pipes collects at a shared bottom surface of the at least two first channels.

21. The ink cartridge according to claim 18, wherein the one or more pipe partitions extend from the upper ends of the at least two ink pipes to the at least two first channels.

22. An ink cartridge body usable with a wide array type printer head, comprising:
an inner space;
one or more dividing walls to divide the inner space and define at least two ink spaces;
at least one ink pipe structure disposed in each of the at least two ink spaces having at least two ink pipes being divided by a partition and each of the at least two ink pipes extending into a corresponding first channel;
at least two second channels corresponding to the at least two ink spaces to receive ink from the at least one ink pipe structure via the corresponding first channel; and
at least one discharge port to receive ink from the at least two second channels and to supply ink to the printer head.

23. The ink cartridge body according to claim 22, wherein the partition extends to a bottom surface of the corresponding first channel so that the ink is collected in the at least two second channels.

24. The ink cartridge body according to claim 22, wherein the partition does not extend to a bottom surface of the corresponding first channel so that the ink is collected in the corresponding first channel.
